(19) United States
(12) Patent Application Publication
(10) Pub. No.: US 2015/0098593 A1
(43) Pub. Date: Apr. 9, 2015

(54) SOUND RECEIVER AND METHOD FOR MANUFACTURING THE SAME

(71) Applicant: FAN-EN YUEH, TAIPEI CITY (TW)

(72) Inventor: FAN-EN YUEH, TAIPEI CITY (TW)

(21) Appl. No.: 14/108,479

(22) Filed: Dec. 17, 2013

(30) Foreign Application Priority Data
Oct. 4, 2013 (TW) 102136004

(51) Int. Cl. H04R 17/02; H04R 31/00; H04R 1/02

(52) U.S. Cl. CPC H04R 17/02; H04R 1/02; H04R 17/025; H04R 31/00
USPC 381/190; 29/25.35

(57) ABSTRACT

A sound receiver includes a casing, a circuit portion, a conductive member, a first piezoelectric plate, a second piezoelectric plate, a first conductive transmission portion, and a second conductive transmission portion. The casing has an accommodating portion. The accommodating portion has an opening and a base. The circuit portion is disposed to close upon the opening. The conductive member having a first side and a second side is disposed in the accommodating portion. The first piezoelectric plate is disposed at the first side of the conductive member within the accommodating portion. The second piezoelectric plate is disposed at the second side of the conductive member within the accommodating portion. The first conductive transmission is configured to elastically and electrically connect the base and the first piezoelectric plate. The second conductive transmission is configured to elastically and electrically connect the circuit portion and the second piezoelectric plate.

### BACKGROUND OF THE INVENTION

1. Field of the Invention

The present disclosure relates to a sound receiver; in particular, to a piezoelectric sound receiver.

2. Description of Related Art

Sound receivers are common in everyday life. Mobile communication devices, voice recorders, sound recorders, and the like all need sound receivers of good quality to receive ambient sound, in particular sound produced by users.

Common sound receivers include condenser microphones and piezoelectric microphones. Most traditional piezoelectric microphones utilize a contact membrane or an elastic material attached on a human body to sense sound wave pressure emitted by the human body, and to transmit the pressure detected to the piezoelectric plate and the piezoelectric plate deforms due to pressure and generates electric voltage.

However, traditional piezoelectric microphones utilize piezoelectric plate to sense sound wave vibration, and a conductive member usually has only one layer of piezoelectric plate attached thereto, or covered by a layer of piezoelectric component. The single layer of piezoelectric plate is limited to sensing sound waves within a specific range, such that it is unable to accurately capture sound waves that are outside the specific range.

### SUMMARY OF THE INVENTION

The object of the present disclosure is to provide a sound receiver whose conductive member vibrates to cause a first piezoelectric plate and a second piezoelectric to respectively generate a first signal and a second signal, so that the sound receiver operable to receive sound over a wider range.

The present disclosure provides a sound receiver including a casing, a circuit portion, a conductive member, a first piezoelectric plate, a second piezoelectric plate, a first conductive transmission portion, and a second conductive transmission portion. The casing has an accommodating portion. An opening is formed on one side of the accommodating portion and a base is formed on the other side of the accommodating portion. The circuit portion is disposed at one side of the accommodating portion and closes the opening. The conductive member having a first side and a second side is arranged in the accommodating portion. The first piezoelectric plate is arranged in the accommodating portion and is disposed at one side of the conductive member. The second piezoelectric plate is arranged in the accommodating portion and is disposed at the second side of the conductive member. The first conductive transmission portion is arranged in the accommodating portion. The first conductive transmission portion is configured to elastically and electrically connect the first piezoelectric plate and the base. The second conductive transmission portion is arranged in the accommodating portion. The second conductive transmission portion is configured to elastically and electrically connect the first piezoelectric plate and the circuit portion.

In an embodiment of the present disclosure, the sound receiver further includes a vibration assisting portion which is disposed on the second piezoelectric plate in the accommodating portion.

In an embodiment of the present disclosure, the casing includes a sound receiving aperture passing through the base for receiving sound waves.

In an embodiment of the present disclosure, the first conductive transmission portion includes at least two conductive elastomers. The conductive elastomers are disposed on the base at two opposite sides of the accommodating portion. Each of the conductive elastomers has a groove for bearing the first piezoelectric plate.

In an embodiment of the present disclosure, the first conductive transmission portion is a conductive elastomer disposed on the base of the accommodating portion.

In an embodiment of the present disclosure, the second conductive transmission portion is a conductive wire, a conductive plate, a conductive member or a conductive spring.

In an embodiment of the present disclosure the material of the first piezoelectric plate and the material of the second piezoelectric plate are different.

In an embodiment of the present disclosure, the conductive member is a metal board, metal column, or a plate-shaped metal body, and the casing is a metal casing.

In an embodiment of the present disclosure, the first piezoelectric plate, the second piezoelectric plate, the conductive member, and the base are parallel to each other.

The present disclosure provides a method of manufacturing a sound receiver, and the method includes: providing a casing having an accommodating portion, wherein an opening is formed on one side of the accommodating and a base is formed on the other side of the accommodating portion; elastically and electrically connecting a first conductive transmission portion to the base; providing a conductive member having a first side and a second side, wherein a first piezoelectric plate is disposed on the first side and a second piezoelectric plate is disposed on the second side; disposing the conductive member in the accommodating portion such that the first piezoelectric plate on the first side of the conductive member is electrically connected to the first conductive transmission portion; and closing the opening on one side of the casing with a circuit portion and electrically connecting the circuit portion and the conductive member with a second conductive transmission portion therebetween.

In summary, the sound receiver of the present disclosure, through vibrations of the conductive member, causes the first piezoelectric plate and the second piezoelectric plate to respectively generate a first signal and a second signal such that the sound receiver can operatively receive sounds over a wide range.

In order to further the understanding regarding the present disclosure, the following embodiments are provided along with illustrations to facilitate the disclosure of the present disclosure.

### BRIEF DESCRIPTION OF THE DRAWINGS

FIG. 1 shows a cross-sectional view of a sound receiver according to an embodiment of the present disclosure;

FIG. 2A to FIG. 2C show schematic diagrams illustrating a method of manufacturing the sound receiver of FIG. 1 according to an embodiment of the present disclosure;

FIG. 3 shows a cross-sectional view of a sound receiver according to another embodiment of the present disclosure;

FIG. 4 shows a cross-sectional view of a sound receiver according to another embodiment of the present disclosure; and

FIG. 5 shows a cross-sectional view of a sound receiver according to another embodiment of the present disclosure.

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

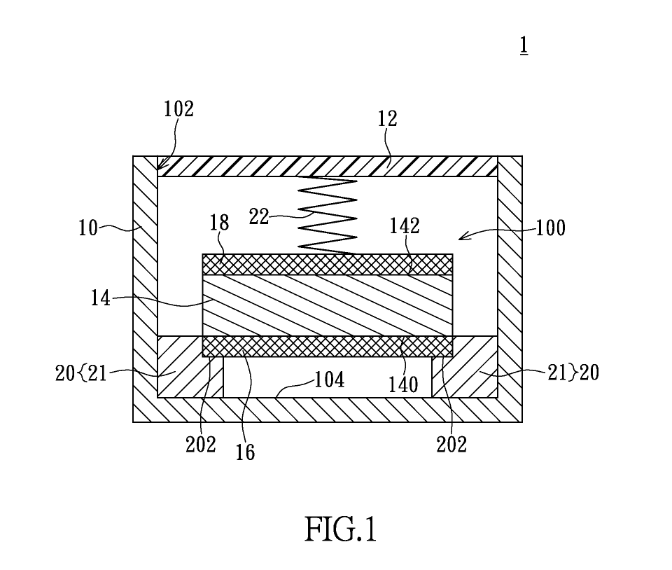

Please refer to FIG. 1, which shows a cross-sectional view illustrating a sound receiver according to an embodiment of the present disclosure. A sound receiver 1 includes a casing 10, a circuit portion 12, a conductive member 14, a first piezoelectric plate 16, a second piezoelectric plate 18, a first conductive transmission portion 20, and a second conductive transmission portion 22. In practice, the conductive member 14, the first piezoelectric plate 16, the second piezoelectric plate 18, the first conductive transmission portion 20, and the second conductive transmission portion 22 are arranged between the casing 10 and the circuit portion 12. By this configuration, the sound receiver 1 can be for example a contact sound receiving device, which is attached to skins around the vocal parts of the human body for generating sound signals in responsive to sound waves detected.

Specifically, the conductive member 14 is electrically connected between the first piezoelectric plate 16 and the second piezoelectric plate 18. The first piezoelectric plate 16 is electrically connected to the first conductive transmission portion 20, the first conductive transmission portion 20 is electrically connected to the casing 10. The casing 10 is electrically connected to the negative terminal of the circuit portion 12. The second piezoelectric plate 18 is electrically connected to the second conductive transmission portion 22, and the second conductive transmission portion 22 is electrically connected to the positive terminal of the circuit portion 12. By this configuration, the sound receiver 1 forms a circuit for receiving sound waves, thereby outputting sound signals.

The casing 10 can be but is not limited to a triangular cup-shaped body, a square cup-shaped body, a circular cup-shaped body, or a polygonal cup-shaped body made of metal. The casing 10 has an accommodating portion 100. An opening 102 is formed at one side of the accommodating portion 100, and a base 104 is formed at the other side of the accommodating portion 100. Additionally, the casing 10 is electrically connected to the negative terminal of the circuit portion 12. Therefore, when the first piezoelectric plate 16, the first conductive transmission portion 20, the casing 10 and the circuit portion 12 conducts, the casing 10 made of metal is negatively charged and has the ability of isolating ambient interference.

The circuit portion 12 is disposed at one side of the accommodating portion 100 and closes the opening 102. By this configuration, the circuit portion 12 closes the opening 102 of the accommodating portion 100 such that the casing 10 and the circuit portion 12 form an enclosed space. Of course, the circuit portion 12 includes capacitors, transistors, or amplifying circuits (not shown in the figures) for processing signals received from the first piezoelectric plate 16 and the second piezoelectric plate 18, e.g. sampling, filtering, amplifying, and the like, and generating a sound signal which is sent to a speaker for broadcast or stored in an electronic device (not shown in the figures).

The conductive member 14 is disposed in the accommodating portion 100 and is substantially parallel to the base 104 of the accommodating portion 100. The conductive member 14, e.g., a board-shaped member, a column-shaped member or a plate-shaped body made of metal, has a first side 140 and a second side 142. The first side 140 is proximal to the base 104 of the accommodating portion 100. The second side 142 is proximal to the opening 102 of the accommodating portion 100. It is worth mentioning that in the present embodiment the conductive member 14 is board-shaped and generates vibration at the first side 140 or the second side 142 according to pressure produced by sound waves.

In practice, the conductive member 14 vibrates responsive to sound waves, such that the first piezoelectric plate 16 on the first side 140 generates a first signal according to the vibration of the conductive member 14, and the circuit portion 12 receives and processes the first signal. The conductive member 14 vibrates responsive to the sound waves, such that the second piezoelectric plate 18 on the second side 142 generates a second signal according to the vibration of the conductive member 14, and the circuit portion 12 receives and processes the second signal. By this configuration, the sound receiver 1 of the present disclosure receives sound waves over a wide range through the conductive member 14, outputs a first signal and a second signal of sounds over different ranges respectively through the first piezoelectric plate 16 or the second piezoelectric plate 18, receives the first signal and the second signal and converts the first signal and the second signal to sound signals through the circuit portion 12.

The first conductive transmission portion 20 is arranged in the accommodating portion 100. The first conductive transmission portion 20 is elastically and electrically connected between the base 104 and the first piezoelectric plate 16. The first conductive transmission portion 20 can be formed of two conductive elastomers 21 disposed on the base 104 at two opposite sides of the accommodating portion 100. Each of the conductive elastomers 21 has a groove 202 for bearing the first piezoelectric plate 16. Specifically, the conductive elastomers 21 can be conductive gel or conductive gel strips having elasticity, the conductive elastomers 21 amount to two and each of the conductive elastomers 21 is an L-shaped column. Therefore, two ends of the first piezoelectric plate 16 are respectively disposed on the grooves 202 of the conductive elastomers 21, such that the first piezoelectric plate 16 vibrates according to the vibration of the conductive member 14 and generates a first signal. The conductive elastomers 21 are elastically and electrically connected to the first piezoelectric plate 16.

For example, the conductive member 14 produces pressure according to vibration of the sound waves, e.g. producing vibration at the first side 140 of the conductive member 14, then the first piezoelectric plate 16 sends a first signal to the casing 10 through the conductive elastomers 21. The first signal is transmitted through the casing 10 to the circuit portion 12. It is worth mentioning that in other embodiments, the first conductive transmission portion 20 can be a single conductive elastomer 21 disposed on the base 104 in the accommodating portion 100, e.g. on the central region of the base 104. In the present embodiment, the position of the first conductive transmission portion 20 being two conductive elastomers 21 is exemplary only and not limited to what is shown in FIG. 1.

It is worth mentioning that the conductive elastomers 21 are elastic and conductive. Therefore, the conductive elastomers 21 increase the amplitude of vibration of the conductive member 14, such that the amplitude of the vibration of the conductive member 14 is increased through the conductive elastic bodies 21. The greater the amplitude of vibration of the conductive member 14, the greater pressure that the first piezoelectric plate 16 and the second piezoelectric plate 18 are subject to and the stronger the signals transmitted. Given same pressure from the sound waves, a sound receiver 1 having a conductive elastomer 21 produces higher electric voltages than a sound receiver 1 without a conductive elastomer 21 such that the sound receiver 1 having a conductive elastomer 21 produces clearer sound signals after processing by the circuit portion 12, thereby increasing the sound receiving sensitivity of the sound receiver 1.

The second conductive transmission portion 22 exemplarily includes but is not limited to a conductive wire, a conductive elastic plate, a conductive member, or a conductive spring. The second conductive transmission portion 22 is arranged in the accommodating portion 100 and is electrically connected between the circuit portion 12 and the second piezoelectric plate 18. The second conductive transmission portion 22 can be for example a conductive elastic plate which is elastically and electrically connected between the electric portion 12 and the second piezoelectric plate 18.

Additionally, in other embodiments, the second conductive transmission portion 22 can be for example a conductive wire. Then, the second conductive transmission portion 22 can be soldered between the second piezoelectric plate 18 and the circuit portion 12. The second conductive transmission portion 22 is electrically connected between the circuit portion 12 and the second piezoelectric plate 18. When the conductive member 14 produces pressure according to the vibration of the sound waves, e.g. producing vibration at the second side 142 of the conductive member 14, the second piezoelectric plate 18 transmits a second signal to the circuit portion 12 through the second conductive transmission portion 22.

It is worth mentioning that the first conductive transmission portion 20 and the second conductive transmission portion 22 are respectively electrically connected to the first piezoelectric plate 16 and the second piezoelectric plate 18. The first conductive transmission portion 20 is electrically connected to the circuit portion 12 through the casing 10. The second conductive transmission portion 22 is directly electrically connected to the circuit portion 12. For example, the first conductive transmission portion 20 functions as the negative terminal of the signal outputted to the circuit portion 12 and the second conductive transmission portion 22 functions as the positive terminal of the signal inputted to the circuit portion 12. Therefore the sound receiver 1 transmits the first signal and the second signal to the circuit portion 12 through the first conductive transmission portion 20 and the second conductive transmission portion 22, respectively and converts the first signal and the second signal to sound signals through the circuit portion 12 such that the sound receiver 1 can sense sound over a wider range.

The first piezoelectric plate 16 is arranged inside the accommodating portion 100 and is disposed at the first side 140 of the conductive member 14. The second piezoelectric plate 18 is arranged inside the accommodating portion 100 and is disposed at the second side 142 of the conductive member 14. In other words, the first piezoelectric plate 16, the second piezoelectric plate 18, the conductive member 14 and the base 104 are parallel to each other. The first piezoelectric plate 16 and the second piezoelectric plate 18 are arranged respectively along the surfaces of the first side 140 and the second side 142 of the conductive member 14, for converting kinetic energy of the vibration of the conductive member 14 into electric potential energy and outputting a signal.

Specifically, the first piezoelectric plate 16 and the second piezoelectric plate 18 have the characteristic of producing electric signals when subject to mechanical pressure. When subject to pressure, the material structures of the first piezoelectric plate 16 and the second piezoelectric plate 18 deform. In order to resists the deformation of the structural arrangement, two sides of the first piezoelectric plate 16 or two sides of the second piezoelectric plate 18 produces positive and negative charges in response to pressure exerted thereon, thereby generating electric voltage across the piezoelectric plates. Therefore, the sound receiver 1 of the present embodiment uses the first piezoelectric plate 16 and the second piezoelectric plate 18 to convert the vibration of the conductive member 14 responsive to sound waves into signals, and process the electric signals through the circuit portion 12.

The material of the first piezoelectric plate 16 and the second piezoelectric plate 18 can be piezoelectric ceramic, piezoelectric crystal, or piezoelectric film. Examples of piezoelectric ceramic are BaTiO₃, lead titanate (PbTiO₃), lead zirconate titanate (PZT), PZT, silver composites, and the like. Examples of common piezoelectric crystals are lithium niobate, potassium niobate, quartz, tourmaline, sodium tartrate, Rochelle slat, and the like. Examples of piezoelectric films are zinc oxide (ZnO), and the like. Additionally, some natural polymers and artificial polymers are also piezoelectric.

It is worth mentioning that the material of the first piezoelectric plate 16 and the material of the second piezoelectric plate 18 may be different. For example, the first piezoelectric plate 16 may be configured to respond to high frequencies and the second piezoelectric plate 18 may be configured to respond to low frequencies. For example, the sound receiver 1 of the present disclosure can sense high-pitched sound and transmit a first signal through the first piezoelectric plate 16, or sense low-pitched sound and transmit a second signal through the second piezoelectric plate 18. The circuit portion 12 receives and processes the first signal corresponding to a high pitch and the second signal corresponding to the low pitch. Therefore, the sound receiver 1 of the present disclosure and receive sound from a wide range.

In the present embodiment, the lengths of the first piezoelectric plate 16, the second piezoelectric plate 18 and the conductive member 14 are substantially equal. Namely, the first piezoelectric plate 16, the second piezoelectric plate 18, and the conductive member 14 overlap. Therefore, the conductive member 14 vibrates responsive to sound waves and provides the first piezoelectric plate 16 and the second piezoelectric plate 18 with energy for producing electric voltages. Additionally, in other embodiments, the length of the first piezoelectric plate 16 and the length of the second piezoelectric plate 18 may be different, the length of the first piezoelectric plate 16 and the length of the conductive member 14 may be different, and the length of the second piezoelectric plate 18 and the length of the conductive member 14 may be different. The lengths of the first piezoelectric plate 16, the second piezoelectric plate 18 and the conductive member 14 are knowledge common in the art and can be designed accordingly by a person skilled in the art.

The sound receiver 1 uses the first piezoelectric plate 16 and the second piezoelectric plate 18 to convert pressure into signals and can be a contact sound receiver 1. As a contact sound receiver 1, it can be attached on skins around the vocal parts of the human body, such as the throat, below the ears, and the like. Pressure produced by the human body during vocalizing vibrates the conductive member 14 of the sound receiver 1 and the first piezoelectric plate 16 and the second piezoelectric plate 18 converts the vibration into signals.

The strength of the signals produced by the first piezoelectric plate 16 or the second piezoelectric plate 18 is proportional to the amplitude of vibration of the conductive member 14 responsive to pressure. When the amplitude of the vibration of the conductive member 14 is greater, the pressure sensed by the first piezoelectric plate 16 or the second piezoelectric plate 18 is greater, and the signals produced by the first piezoelectric plate 16 or the second piezoelectric plate 18 is also greater. Given the same pressure produced by sound waves, the length of the conductive member 14 is proportional to its amplitude of vibration. Therefore, the longer the conductive member 14, the stronger the signal generated by the first piezoelectric plate 16 and the second piezoelectric plate 18, and a stable and clear signal can be generated by the sound receiver 1 even in response to sound waves of small vibration. Therefore in the present embodiment a longer conductive member 14 increases the sensitivity of the sound receiver 1.

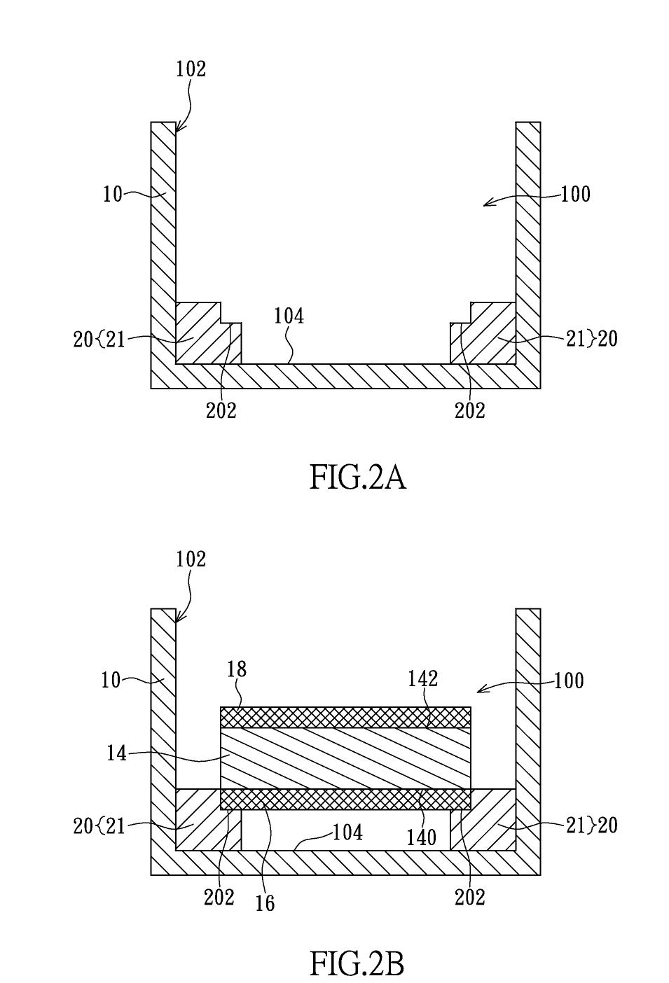

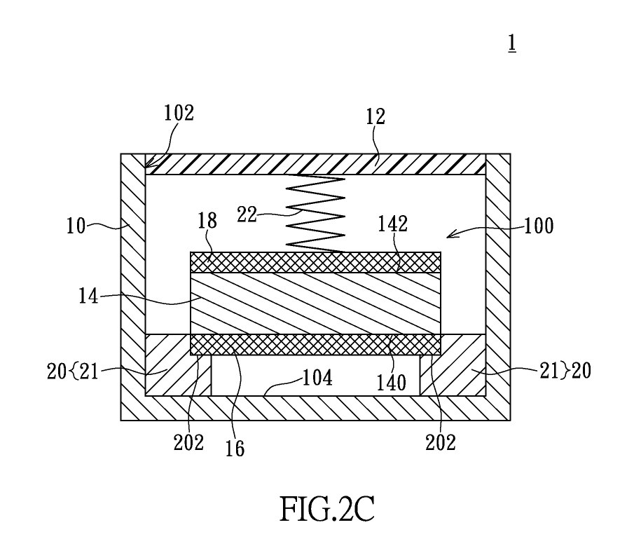

The above describes the structure of the sound receiver according to an embodiment of the present disclosure. The following describes the method of manufacturing the sound receiver according to FIG. 1. FIG. 2A to FIG. 2C show schematic diagrams of a method of manufacturing the sound receiver of FIG. 1 according to an embodiment of the present disclosure.

Referring to FIG. 2A, a casing 10 is provided. The casing 10 has an accommodating portion 100. An opening 102 is formed at one side of the accommodating portion 100, and a base 104 is formed at the other side of the accommodating portion 100. Next, the two conductive elastic bodies 21 bodies are disposed on the base 104 at two opposite sides of the accommodating portion 100. The conductive elastomers 21 are for example two elastic conductive gel strips and each of the conductive elastomers 21 has a groove 202, such that each of the conductive elastomers 21 is an L-shaped column. By this configuration, the conductive elastomers 21 are the first conductive transmission portion 20, and the first conductive transmission portion 20 is elastically and electrically connected to the base 104 as shown in FIG. 2.

Referring to FIG. 2B, the first piezoelectric plate 16 is disposed at the grooves 202 of the conductive elastic bodies 21, such that two ends of the first piezoelectric plate 16 are respectively connected to the conductive elastic bodies 21. Next, the conductive member 14 is disposed on the piezoelectric plate 16. Finally, the second piezoelectric plate 18 is disposed on the conductive member 14. Therefore, the conductive member 14 is disposed between the first piezoelectric plate 16 and the second piezoelectric plate 18, the first piezoelectric plate 16 is proximal to the base 104 of the accommodating portion 100, and the second piezoelectric plate 18 is proximal to the opening 102 of the accommodating portion 100.

Alternatively, the manufacturing process can first provide a conductive member 14 having a first side 140 and a second side 142. The first piezoelectric plate 16 is disposed on the first side 140 and the second piezoelectric plate 18 is disposed on the second side 142, and then the conductive member 14 is arranged in the accommodating portion 100 such that the first piezoelectric plate 16 at the first side 140 of the conductive member is electrically connected to the first conductive transmission portion 20. By this method, the conductive member 14, the first piezoelectric plate 16 and the second piezoelectric plate 18 can be preemptively attached, and then the attached first piezoelectric plate 16, the conductive member 14 and the second piezoelectric plate 18 can be disposed together on the first conductive transmission portion 20. So, workers can facilitate the process of disposing the first piezoelectric plate, the conductive member 14, and the second piezoelectric plate 18 onto the first conductive transmission portion 20.

Referring to FIG. 2C, the circuit portion 12 is disposed at one side of the casing 10 and is closed upon the opening 102, such that the casing 10 and the circuit portion 12 form an enclosed space. A second conductive transmission portion 22 is electrically connected between the circuit portion 12 and the second piezoelectric plate 18. In practice, the circuit portion 12 may be soldered to the second conductive transmission portion 22, which is a conductive elastic plate. Therefore, when the circuit portion 12 is closed upon the opening 102 of the accommodating portion 100, the second conductive transmission portion 22 elastically presses against the second piezoelectric plate 18 and is electrically connected thereto. Additionally, in other embodiments, the second conductive transmission portion 22 can be for example a conductive wire soldered to the circuit portion 12 and the second piezoelectric plate 18. When the circuit portion 12 is closed upon the opening 102 of the accommodating portion 100, the second conductive portion 22 is accommodated in the accommodating portion 100.

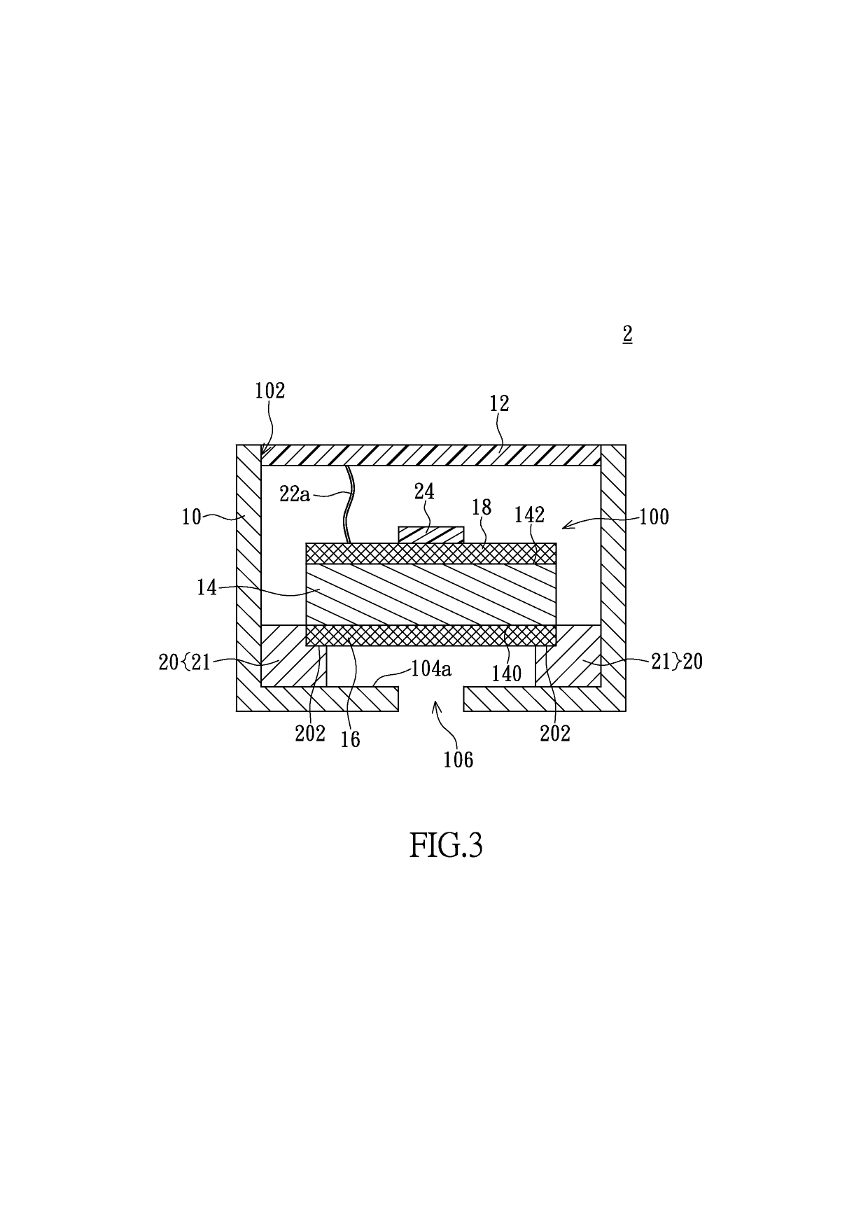

FIG. 3 shows a cross-sectional view of a sound receiver according to another embodiment of the present disclosure. The sound receiver 2 of FIG. 3 is different from the sound receiver 1 of FIG. 1 in that the sound receiver 2 further includes a vibration assisting portion 24. The casing 10 further includes a sound receiving aperture 106, and the second conductive transmission portion 22a is a conductive wire. Specifically, the vibration assisting portion 24 is arranged in the accommodating portion 100 and is disposed on the second piezoelectric plate 18 for increasing the amplitude of vibration of the conductive member 14. For example, the vibration assisting portion 24 can be dense and relatively heavy object such as metal, a heavy weight, and the like for increasing the amplitude of vibration of the conductive member 14 during vibration.

As exemplarily shown in FIG. 3, the first piezoelectric plate 16, the conductive member 14 and the second piezoelectric plate 18 are each a board body. The vibration assisting portion 24 is a metal weight disposed on the second piezoelectric plate 18, for example at the central region of the second piezoelectric plate 18 for increasing the weight of the conductive member 14 during vibration, such that the amplitude of vibration of the conductive member 14 is adjusted according to principles of oscillation. Additionally, metal weights of differing weights can be used so to adjust the amplitude of vibration of the conductive member 14.

When the amplitude of vibration of the conductive member 14 is greater, the first piezoelectric plate 16 and the second piezoelectric plate 18 are subject to greater pressure and thereby generate stronger signals. Given the same pressure from the sound wave, the sound receiver 2 having the vibration assisting portion 24 produces a greater voltage compared to the sound receiver 1 without the vibration assisting portion 24, such that the sound signal produced by the circuit portion 12 after processing is clearer, thereby increasing the sound receiving sensitivity of the sound receiver 2.

The casing 10 is formed with the sound receiving aperture 106 which passes through the base 104a for allowing sound waves outside the sound receiver 2, e.g. vibration produced by people when talking, into the accommodating portion. By this method, the sound receiver 2 of the present embodiment can be a non-contact sound receiver 2. As a non-contact sound receiver 2, it can receive pressure transmitted by sound waves when people vocalize, such that the conductive member 14 of the sound receiver 2 vibrates and the first piezoelectric plate 16 and the second piezoelectric plate 18 produces signals according to the vibration.

Additionally, the second conductive transmission portion 22a can be for example a conductive wire soldered to the circuit portion 12 and the second piezoelectric plate 18. When the circuit portion 12 is closed upon the opening 102 of the accommodating portion 100, the second conductive transmission portion 22a is accommodated in the accommodating portion 100 for transmitting a second signal.

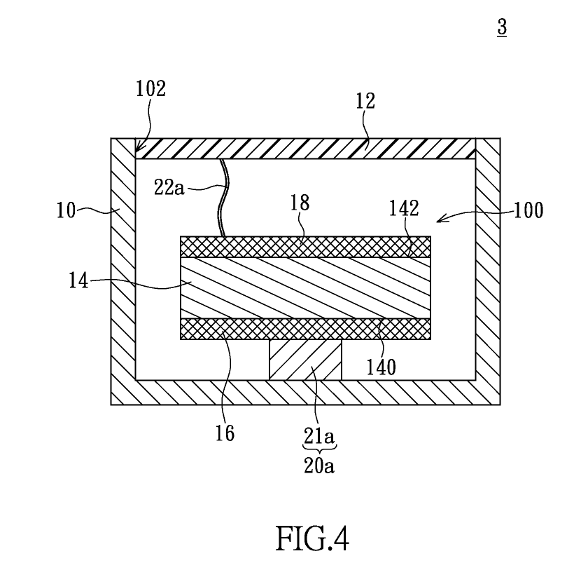

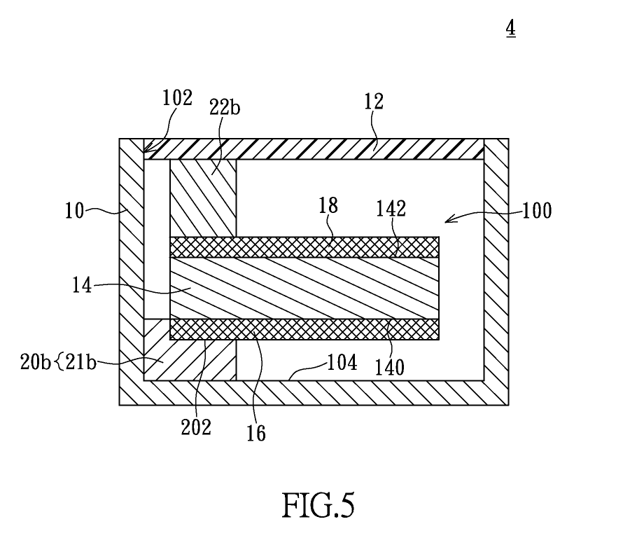

FIG. 4 shows a cross-sectional view of a sound receiver according to another embodiment of the present disclosure. The sound receiver 3 of FIG. 4 is different from the sound receiver 1 of FIG. 1 in that the first conductive transmission portion 20a is a single conductive elastomer 21a, which is disposed on the base 104 of the accommodating portion 100. In practice, the conductive elastomer 21a is disposed at the central region of the base 104 such that two ends of the first piezoelectric plate 16 are not directly supported, and the first piezoelectric plate 16 and the first conductive transmission portion 20a form a T-shape. By this configuration, the first piezoelectric plate 16 transmits a first signal to the circuit portion 12 through the first conductive transmission portion 20a.

FIG. 5 shows a cross-sectional view of a sound receiver according to another embodiment of the present disclosure. The sound receiver 4 of FIG. 5 is different from the sound receiver 1 of FIG. 1 in that the first conductive transmission portion 20b is a single conductive elastomer 21b, which is disposed in the accommodating portion 100 and is configured to elastically and electrically connect the base 104 and the first piezoelectric plate 16. The conductive elastomer 21b is disposed on the base 104 at one side of the accommodating portion 100, as shown in FIG. 5. Similarly, the second conductive transmission portion 22b is for example a conductive member whose position corresponds to the position of the conductive elastomer 21b. The second conductive transmission portion 22b is configured to electrically connect the circuit portion 12 and the second piezoelectric plate 18. When the circuit portion 12 is closed upon the opening 102 of the accommodating portion 100, the second conductive transmission portion 22b and the first conductive transmission portion 20b clamp or fix the conductive member 14, and the first piezoelectric plate 16 and the second piezoelectric plate 18 are respectively disposed at two sides of the conductive member 14. By this configuration, one of two ends of the conductive member 14 is suspended in the air in the accommodating portion 100, as shown in FIG. 5.

In other embodiments, the second conductive transmission portion 22b and the first conductive transmission portion 20b can clamp or fix one of the two ends of the conductive member 14, and the first piezoelectric plate 16 and the second piezoelectric plate 18 are respectively disposed at the two sides of the conductive member 14, e.g. the right end of the conductive member 14 suspended in the air in the accommodating portion 100, or the left end of the conductive member 14 suspended in the air in the accommodating portion 100. The present embodiment does not limit the method by which the second conductive transmission portion 22b and the first conductive transmission portion 20b clamps or fixes the first piezoelectric plate 16, the conductive member 14 and the second piezoelectric plate 18.

Of course, the sound receiver 4 can receive vibrations of sound waves over different ranges through the conductive member 14, produce a first signal or a second signal of different sound ranges through the first piezoelectric plate 16 or the second piezoelectric plate 18, and receive and process the first signal or the second signal through the circuit portion 12.

In summary of the above, the present disclosure provides a sound receiver which generates a first signal and a second signal by vibrating the first piezoelectric plate and the second piezoelectric plate through the conductive member, and transmits the first signal and the second signal to the circuit portion through the first conductive transmission portion and the second conductive transmission portion. The circuit portion receives and processes the first signal and the second signal. The sound receiver of the present disclosure can receive sound over a wide range. Additionally, the sound receiver is easier and cheaper to manufacture and flexibly adjusted.

The descriptions illustrated supra set forth simply the preferred embodiments of the present disclosure; however, the characteristics of the present disclosure are by no means restricted thereto. All changes, alternations, or modifications conveniently considered by those skilled in the art are deemed to be encompassed within the scope of the present disclosure delineated by the following claims.

What is claimed is:

1. A sound receiver, comprising:
a casing having an accommodating portion, wherein an opening is formed at one side of the accommodating portion and a base is formed at another side of the accommodating portion;
a circuit portion, disposed at one side of the accommodating portion and closed upon the opening;
a conductive member having a first side and a second side disposed in the accommodating portion;
a first piezoelectric plate, arranged in the accommodating portion and disposed at the first side of the conductive member;
a second piezoelectric plate, arranged in the accommodating portion and disposed at the second side of the conductive member;
a first conductive transmission portion, arranged in the accommodating portion and configured to elastically and electrically connect the base and the first piezoelectric plate; and
a second conductive transmission portion, arranged in the accommodating portion and configured to elastically and electrically connect the circuit portion and the second piezoelectric plate.

2. The sound receiver according to claim 1, further comprising a vibration assisting portion, arranged in the accommodating portion and disposed on the second piezoelectric plate.

3. The sound receiver according to claim 1, wherein the casing further comprises a sound receiving aperture passing through the base.

4. The sound receiver according to claim 1, wherein the first conductive transmission portion comprises at least two conductive elastomers, the conductive elastomers are arranged on the base at two opposite sides of the accommodating portion, and each of the conductive elastomers has a groove for bearing the first piezoelectric plate.

5. The sound receiver according to claim 1, wherein the first conductive transmission portion is a conductive elastomer disposed on the base of the accommodating portion.

6. The sound receiver according to claim 1, wherein the second conductive transmission portion is an element selected from the group consisting of a conductive wire, a conductive plate, a conductive member, and a conductive spring.

7. The sound receiver according to claim 1, wherein the material of the first piezoelectric plate and the material of the second piezoelectric plate are different.

8. The sound receiver according to claim 1, wherein the conductive member is an element selected from the group consisting of a metal board, a metal column, and a metal plate, and the casing is a metal casing.

9. The sound receiver according to claim 1, wherein the first piezoelectric plate, the second piezoelectric plate, the conductive member, and the base are parallel to each other.

10. A method of manufacturing a sound receiver, the method comprising:
providing a casing having an accommodating portion, wherein an opening is formed at one side of the accommodating portion and a base is formed at the other side of the accommodating portion;
elastically connecting a first conductive transmission portion to the base;
providing a conductive member having a first side and a second side, wherein a first piezoelectric plate is disposed at the first side and a second piezoelectric plate is disposed at the second side;
disposing the conductive member in the accommodating portion, wherein the first piezoelectric plate at the first side of the conductive member is electrically connected to the first conductive transmission portion; and
closing a circuit portion upon the opening on one side of the casing, and electrically connecting a second conductive transmission portion between the circuit portion and the second piezoelectric plate.

11. The method of manufacturing a sound receiver according to claim 10, wherein the first conductive transmission portion is a conductive elastomer.

12. The method of manufacturing a sound receiver according to claim 10, wherein the second conductive transmission portion is an element selected from the group consisting of a conductive wire, a conductive plate, a conductive member, and a conductive spring.

13. The method of manufacturing a sound receiver according to claim 10, wherein the material of the first piezoelectric plate and the material of the second piezoelectric plate are different.

14. The method of manufacturing a sound receiver according to claim 10, wherein a vibration assisting portion is disposed at one side of the second piezoelectric plate.
